(19) United States
(12) Patent Application Publication
(10) Pub. No.: US 2016/0371526 A1
(43) Pub. Date: Dec. 22, 2016

(54) OPTICAL DECODER FOR THERMAL BARCODES

(71) Applicant: Northeastern University, Boston, MA (US)

(72) Inventors: Ming SU, Newton, MA (US); Sichao HOU, Boston, MA (US); Miao WANG, Boston, MA (US)

(21) Appl. No.: 15/186,029

(22) Filed: Jun. 17, 2016

Related U.S. Application Data
(60) Provisional application No. 62/308,978, filed on Mar. 16, 2016.
(60) Provisional application No. 62/180,770, filed on Jun. 17, 2015.

(51) Int. Cl. G06K 7/14; G06K 19/06; G01N 21/35

(52) U.S. Cl. CPC G06K 7/1413; G01N 21/35; G06K 19/0615

(57) ABSTRACT

A high capacity nanoparticle-based covert barcode system relies on an entirely optical readout for detection. The system includes a panel of phase change nanoparticles with sharp and discrete melting peaks; readout is based on heating with an infrared source and detection using an infrared imager, and detection of their phase transition temperatures and positions. A readily detectable and sudden change in temperature occurs at the phase transition during a heating or cooling process, and can be used to indicate the identity of nanoparticles.

### CROSS REFERENCE TO RELATED APPLICATIONS

This application claims the priority of U.S. Provisional Application No. 62/308,978 filed Mar. 16, 2016 and entitled “Optical Decoder for Thermal Barcodes”; and claims priority to U.S. Provisional Application No. 62/180,770 filed Jun. 17, 2015 and entitled “All-Optical Thermal Barcode Reader”. Both of said provisional applications are hereby incorporated by reference in their entireties.

### STATEMENT REGARDING FEDERALLY SPONSORED RESEARCH OR DEVELOPMENT

This invention was developed with financial support from Grant Number 105599 from the National Science Foundation, and Grant Number 2012-DN-BX-K021 from the United States Department of Justice. The U.S. Government has certain rights in the invention

### BACKGROUND

Barcodes such as Universal Product Codes (UPC) are ubiquitously used to tag trading objects, but the visible barcodes can be altered or duplicated, facing increasing challenges such as product counterfeiting and unlawful use of objects (1). To protect product authentication, covert (invisible) taggants can be added to objects of interest (explosives, drug formulations, papers or inks) during manufacturing processes so that each object has its own code for tracking purposes (2,3). Forensic investigation can thus be enhanced by tracing a specific object to its manufacturer, vendor or purchaser. However, existing taggants have various deficiencies. Molecular or chemical taggants are not suitable for serialization due to the small coding space (4). Fluorescent taggants are limited by availability of materials with minimal spectral overlap (5). Glass/plastic microspheres and fibers are often used as taggants, but have low coding capacity (6,7). Graphical coding achieved by lithography is limited by structural integrity, material choice, and imaging identification (8,9). DNA barcodes offer high coding capacity, but they can be degraded under ambient conditions and require amplification by polymerase chain reaction for readout (10).

Small sized nanoparticles have potential as covert barcodes, but the lack of nanoparticle-specific physical properties restricts their ability to label each object in a series. Briefly, there is no particle-specific magnetic or electrochemical property, meaning that one type of nanoparticle cannot be distinguished from others of the same type based on its magnetic or electro-chemical properties. Semiconducting or metallic nanoparticles have broad fluorescence or plasmonic emission peaks (peak width at half height of 150 nm), which limits the type of optically distinguishable nanoparticles between 400-900 nm to only a few (11). Plasmonic nanoparticle enhanced Raman scattering has sharp peaks over a large wavelength range, but available Raman active dyes are limited, and quantitative signals are hard to obtain (12). Metallic nanorods containing alternating layers of metals require a high resolution optical microscope to detect optical contrast between adjacent segments (13).

A recently developed nanoparticle-based high capacity covert barcode system has been developed in which a panel of phase change nanoparticles with sharp and discrete melting peaks are used as covert barcodes (14). The barcodes are read by detecting the solid-to-liquid phase changes of the nanoparticles, where the melting points and enthalpy of each type of nanoparticles are measured (15-20). The method of reading nanoparticle-based barcodes relies on differential scanning calorimetry (DSC) analysis, which requires destructively sampling the taggant and placing the sample into a DSC pan, a process that is time consuming and cannot be performed remotely as with a common laser barcode scanner (21-24). Therefore, there is an unmet need for new and improved covert taggants and methods for their identification.

### SUMMARY OF THE INVENTION

The present invention provides a high capacity nanoparticle-based covert barcode system that relies on an entirely optical readout for its detection. The system includes a panel of phase change nanoparticles that have sharp and discrete melting peaks and that can be read by the detection of their solid-to-liquid or liquid-to-solid phase transitions. In order to achieve high coding capacity, pure substances and their eutectic mixtures can be used to make nanoparticles, where sharp melting peaks exist over a large temperature range. In this system, an infrared light is used to quickly heat up the taggant, and a thermal imager (such as infrared camera) is used to collect thermal images of the taggant continuously while the sample is being heated up, cooled down, or both. A readily detectable and sudden change in temperature occurs at the phase transition during the heating and/or cooling process, and can be used to indicate the identity of nanoparticles.

One aspect of the invention is a taggant including a plurality of phase change nanoparticles disposed in a two-dimensional array. The plurality of phase change nanoparticles can include one or more types of phase change nanoparticles, each type having a uniquely identifiable phase change temperature.

Another aspect of the invention is a tagged object including the above-described taggant.

Yet another aspect of the invention is the identification of an object using a taggant. The method includes the steps of: (a) providing an object tagged with the taggant of claim 1; (b) irradiating the taggant with infrared radiation, whereby a temperature of the taggant increases over time; (c) scanning or acquiring an image of the taggant with an infrared imaging device over a period of time; (d) determining a phase change temperature and a position of the phase change nanoparticles; and (e) identifying the object by matching the phase change temperature and position of said phase change nanoparticles with predetermined values for said phase change temperature and position in a library.

Still another aspect of the invention is a taggant reading system, including an infrared illumination source; an infrared imaging device; and a processor; wherein the processor is programmed to direct the illumination source and imaging device to carry out the above-described method.

Another aspect of the invention is a method for making a taggant, including depositing a plurality of phase change nanoparticles in a two dimensional array, wherein the plurality of phase change nanoparticles comprises one or more types of phase change nanoparticles, each type having a uniquely identifiable phase change temperature within the plurality of phase change nanoparticles.

Yet another aspect of the invention is a method for tagging an object, including associating the above-described taggant with an object.

### BRIEF DESCRIPTION OF THE DRAWINGS

FIG. 1A is a schematic representation of an embodiment of an infrared thermal barcode system (taggant reading system), including a four-spot thermal barcode (taggant). FIGS. 1B-1D illustrate different exemplary embodiments of two-dimensional arrangements of the phase change nanoparticles within a taggant. FIG. 1B shows a four-spot barcode containing four different types of phase change nanoparticles. FIG. 1C shows a four-spot barcode containing one type of phase change nanoparticle. FIG. 1D shows a thermal barcode containing four different types of phase change nanoparticles arranged in a taggant.

FIGS. 2A-2F show thermal images of a melting process for nanoparticles containing stearic acid (1), palmitic acid (2), lauric acid (3) and icosane (4) acquired over time using an infrared camera.

FIG. 3A shows a temperature increase curve for nanoparticles containing stearic acid (1), palmitic acid (2), lauric acid (3) and icosane (4). FIG. 3B shows a temperature decrease curve of stearic acid (1), palmitic acid (2), lauric acid (3) and icosane (4). FIG. 3C shows differential scanning calorimetry (DSC) curves of a heating process of nanoparticles containing stearic acid (1), palmitic acid (2), lauric acid (3) and icosane (4). FIG. 3D shows DSC curves of a cooling process of nanoparticles containing stearic acid (1), palmitic acid (2), lauric acid (3) and icosane (4).

FIG. 4A shows the temperature increase rate for nanoparticles of stearic acid (1), palmitic acid (2), lauric acid (3) and icosane (4). FIG. 4B displays the temperature decrease rate of stearic acid (1), palmitic acid (2), lauric acid (3) and icosane (4).

FIGS. 5A-5C show temperature increase profiles and temperature change rates for thermal barcodes consisting of 4 types of phase change materials in a particular order. FIG. 5A shows a taggant containing stearic acid (S), palmitic acid (P), lauric acid (L), and icosane (I) nanoparticles in that order (SPLI). FIG. 5B shows results for the same nanoparticles arranged inthe order LIPS, and FIG. 5C arranged in the order LPIS.

FIGS. 6A-6D present DSC curves (FIGS. 6A-6B) and temperature profiles (FIGS. 6C-6D) during a heating and cooling cycle of a sample of stearic acid nanoparticles.

FIGS. 7A-7D present DSC curves (FIGS. 7A-7B) and temperature profiles (FIGS. 7C-7D) during a heating and cooling cycle of a sample of palmitic acid nanoparticles.

FIGS. 8A-8B present DSC curves, and FIG. 8C presents a temperature profile, of a sample of Bi—Pb—Sn alloy nanoparticles.

### DETAILED DESCRIPTION OF THE INVENTION

The present invention provides an all-optical readout system for detection of thermal barcodes. The infrared detection technique overcomes some major limitations of non-optical thermal scanning methods, such as DSC. DSC provides low temperature resolution (poor peak separation) at high heating rates, while the infrared imaging method maintains a high temperature resolution. The width of the peaks in DSC curves increases as the heating rate increases and the peaks of different taggant components will overlap. On the other hand, the width of peaks (temperature change rate vs. temperature) obtained from the present infrared method is independent of the heating rate. DSC measurement also has low throughput, and each time only one sample can be tested. The present infrared detection technique is a high throughput method that can measure more than ten samples simultaneously. Thus, the measurement time is much shorter. The thermal imaging method is a non-destructive approach, and the samples are able to be used repeatedly through heating-cooling cycles. On the other hand, DSC has to be performed after placing samples in aluminum pans, which are not able to be recycled.

The infrared heating and imaging techniques provide a non-contact and highly sensitive way to characterize material properties and decode thermal barcodes at high spatial resolution.

In some embodiments, the present invention comprises a taggant including a variety of phase change nanoparticles disposed in a two-dimensional array. This variety of phase change nanoparticles can include one or more types of phase change nanoparticles, each type having a uniquely identifiable phase change temperature. The use of optical methods preserves the position and arrangement of different taggant components, therdby allowing the encoding of more information. In some embodiments, the phase change nanoparticles can be optically heated and scanned or imaged in order to reveal their phase change temperature and position within the array, without the need for taggant sampling or destruction.

Solid materials can change to liquid phase at their melting temperatures. During the melting process, the temperature of the solid does not rise until it is completely molten. If the dimension of the solid is sufficiently small, the time it takes for phase transition can be negligible, and there is a sharp melting peak during the thermal scan or imaging. For this reason, taggant components in the present invention are preferably in the form of nanoparticles, having a size range from about 1 nm to about 999 nm, or about 10 nm to 500 nm, or about 10 nm to about 250 nm, or about 10 nm to about 100 nm, or about 10 nm, about 20 nm, about 30 nm, about 40 nm, about 50 nm, about 60 nm, about 70 nm, about 80 nm, about 90 nm, about 100 nm, about 120 nm, about 150 nm, about 200 nm, or about 300 nm in diameter. In some embodiments, phase change microparticles (1-999 μm) or even millimeter-sized particles can be used to form the taggant.

The taggant nanoparticles for use in the invention can be any type of solid material or combination of materials that is normally solid under ambient conditions, such as from about 0 to about 50° C. The materials should have a phase change (i.e., melting point) above ambient conditions, and preferably exhibit a rapid phase change over a narrow temperature range. Many types of solid materials have large volumetric latent heats of fusion and are stable over a large temperature range. In some embodiments, the phase change nanoparticles include one or more paraffin waxes. In some embodiments, the phase change nanoparticles include liquid crystals, proteins, organic acids, DNA, or a combination thereof. The melting temperature is typically dependent on the atomic number (for metals) and composition (for alloys and biologic materials), as well as on molecular size or chain length (for paraffin waxes) providing that the size of material is larger than the thermodynamic threshold size (20 nm), below which surface atoms will contribute more and cause reduction of melting temperature.

In some embodiments, the phase change nanoparticles of the present disclosure can be made of or can include metals such as aluminum, bismuth, cadmium, copper, gadolinium, indium, lead, magnesium, palladium, and silver. This sample collection of metals can form 10 types of metal nanoparticles, 45 type of binary alloy nanoparticles, 120 types of ternary eutectic alloy nanoparticles, 210 types of quaternary eutectic alloy nanoparticles, and so on. The total number of metals and eutectic alloys can reach 1,023. Nanoparticles of these metals and eutectic alloys can have sharp and discrete melting peaks that can be resolved with high peak resolution (0.01° C.).

Nanoparticles with unique physical properties are useful as covert taggants for several reasons: (1) the small size of nanoparticles makes them invisible to the naked eye; (2) they can be added in many matrix materials without changing the property of the host; (3) a variety of properties such as optical, magnetic, electric, and electrochemical properties can be considered as possible means of readout; (4) nanoparticles or their liquid suspensions can be printed and stamped on objects as inks or ink additives. In some embodiments, the taggant is invisible to the unaided human eye (i.e., is covert). In some embodiments, the phase change nanoparticles are encapsulated in microspheres. In some embodiments, the taggant further includes nanoparticles selected from the group consisting of magnetic nanoparticles, fluorescent nanoparticles, semiconductive nanoparticles, and combinations thereof. In some embodiments, the taggant can include 1, 2, 3, 4, 5, 6, 7, 8, 9, 10 or more types of phase change nanoparticles, such as 2-10, 2-5, 3-10, 3-5, 3-7, 5-7, or 5-10 different types, each having a different and distinguishable melting temperature. Furthermore, the phase-change nanoparticles selected for a given taggant can be selected from a library of phase-change nanoparticles having up to hundreds or even thousands of possible options for obtaining a desired combination.

The taggants of the present invention provide a large coding space. That is, there are many unique thermal readouts or signatures that can be created with the taggants of the present disclosure. 100 types of nanoparticles with distinct melting temperatures can be used to construct covert taggants with the total combination of (2¹⁰⁰−1) or 10³⁰, which is large enough to cover each document, currency note, bullet, or vehicle of a production run or model type. By virtue of its large coding space and two-dimensional quality, in some embodiments the two-dimensional array represents a serial number.

Counterfeits generate serious issues for many industrial sections such as pharmaceuticals, airplane parts, auto parts, and clothing, etc. There are urgent commercial and forensic needs for a method that is capable of identifying product/materials, preventing fraud, or deterring counterfeits with high reliability and minimal effort. Bar codes printed on packages or color shifting inks/films or holograms are vulnerable to forgery because of their visibility and easiness to imitate, substitute, or adulterate. Optical bar codes depending on up-converting phosphors, fluorescence, and ultraviolet afterglow can be fabricated easily because of their low cost. At present, counterfeiters can copy most anti-counterfeiting technologies within 18 months. The thermal taggants of the present disclosure may be designed so that they can be extremely difficult or impossible to reverse-engineer them. People outside government agency or a designated company that manufacture taggants can have a hard time trying to imitate the taggant system of the present invention, because the nanoparticles of the taggant cannot be seen or touched. Characterizing nanoparticle compositions can require sophisticated instruments (i.e., transmission electron microscope) that are only available at limited research organizations. Generating a large panel of nanoparticles of different compositions can be a challenge to non-professionals due to multiple materials required and processing techniques required.

In some embodiments, multi-functional taggants can be built by incorporating thermal, magnetic and fluorescent nanoparticles together, which provides multi-layered authentications that are even more difficult to be reconstructed. In some embodiments, multi-layered authentication that combines overt and covert layers can be employed. Such a combined system may provide significant barrier to counterfeit or simulation, where overt layer is for public use, semi-covert layer for field use, and covert layer for investigative or forensic use. In some embodiments, multi-functional microspheres can be provided. For example, both covert thermal taggants and overt fluorescent taggant can be encapsulated inside silica or polymer microspheres with super-paramagnetic iron oxide nanoparticles (for taggant collection). The magnetic collection allows elimination of separation and extraction step. In some embodiments, iron oxide nanoparticles and cadmium sulfide/zinc sulfide quantum dots can be used. Quantum dots of different color can be used to form overt layer. These taggants can be extracted and recovered from powers (dust), papers or liquid extracts. The ratios of thermal, magnetic and fluorescent nanoparticles, can be tuned to achieve a balanced combination of multiple functions. In various embodiments, the structure, magnetic and fluorescent properties of multi-functional taggant can be tested by using, in addition to thermal imaging, DSC, scanning electron microscope (SEM), Superconducting Quantum Interference Device (SQUID), or a fluorescence spectrometer.

In some embodiments, a tagged object includes the above-described taggant. The taggant can be integrated into the material of which the object is made, or attached to its surface, for example.

In some embodiments, the present invention provides methods for using the above-mentioned taggants for identification and analysis of evidence. In some embodiments, there is provided a method for identifying an object comprising irradiating the taggant with infrared radiation, whereby a temperature of the taggant increases over time; scanning or acquiring an image of the taggant with an infrared imaging device over a period of time; determining a phase change temperature and a position of the phase change nanoparticles; and identifying the object by matching the phase change temperature and position of said phase change nanoparticles with predetermined values for said phase change temperature and position in a library. The library can be developed by obtaining the thermal profile of a taggant incorporated into an object and associating this thermal profile with the object in a database. In some embodiments, there is provided a method of tagging an object comprising adding to an object a plurality of phase change nanoparticles of one or more types, each type having a uniquely identifiable phase change temperature. A thermal profile of the phase change nanoparticles can then be generated and associated with the object in a library.

In some embodiments, the phase change temperature is determined by detecting one or more melting peaks indicative of the phase change temperatures of the nanoparticles. In some embodiments of the method, the phase change nanoparticles undergo a solid-to-liquid, or a liquid-to-solid phase transition. Since infrared imaging does not require sampling of the taggant, and can be performed remotely, in some embodiments the taggant is continuously scanned or imaged as it is heated up and/or cooled down according to the above-mentioned method. In some embodiments, the present invention provides a a taggant reading system, including an infrared illumination source; an infrared imaging device; and a processor. This processor can be programmed to direct the illumination source and imaging device to carry out the above-described method. In some embodiments, the imaging device is a thermography camera. In some embodiments, the processor is programmed to detect a code corresponding to a particular taggant and to transmit and/or display the code when detected. In some embodiments, the processor is programmed to compare the code to a predetermined set of codes indicative of no identification or positive identification, and to transmit or display an identification or non-identification result.

In some embodiments, the present invention provides a method for making a taggant, including depositing a plurality of phase change nanoparticles in a two dimensional array, wherein the plurality of phase change nanoparticles comprises one or more types of phase change nanoparticles, each type having a uniquely identifiable phase change temperature within the plurality of phase change nanoparticles.

In some embodiments, the present invention provides a method for tagging an object, including associating the above-described taggant with an object. The taggant may be combined with, implanted into, connected to, or embedded in the object. In some embodiments, the taggant may be disposed on the surface of the object or otherwise connected to the surface of the object. The taggant can also be produced on a patch or label that is attached to or integrated within the object. Other methods of linking the taggant to the object may also be used.

In some embodiments, the present invention provides a method that can be used for thermal barcode decoding and analyzing any other thermal properties of materials. In some embodiments, the present invention can be used to enhance early diagnosis of many types of cancers, including breast cancer.

### EXAMPLES

### Example 1

### Characterization of Nanoparticles Using Their Melting Temperature

Stearic acid, palmitic acid, lauric acid and icosane were obtained with melting temperatures of 69.3, 62.9, 43-45, and 36-38° C., respectively. 10-20 mg of samples were placed in an aluminum alloy sample disk and heated with a radiant infrared electric heater (IR30S) and cooled down to room temperature. An infrared camera (FLIR T430sc) was used to record the temperature change of the thermal barcode during heating and cooling processes. A differential scanning calorimeter (PerkinElmer DSC7) was used to measure the thermal properties of materials at thermal ramp rate 10° C./min within the range of 25 to 90° C. The cooling rate was controlled to be at 10° C./min within the range of 90 to 0° C. by using a water cooling unit. The infrared camera was connected to a computer via a data line, and an FLIR tools+ software was used to record and analysis the data collected from barcodes.

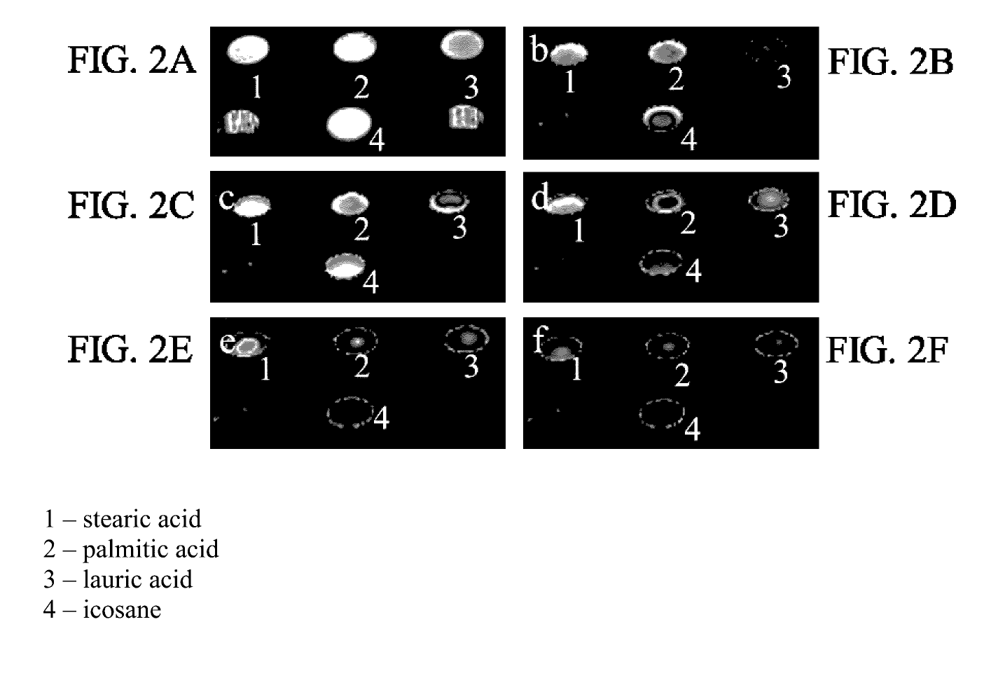

FIGS. 2A-2F show thermal images of four phase change materials in the different stages of the melting process. The material (stearic acid, palmitic acid, lauric acid or icosane) in each slot can be seen clearly against background (FIG. 2A), indicating different emissivity of each material and background. The color contrast in slot 4 (FIG. 2B) indicate partial melting of the sample while the others are still in the solid state. As temperature increases, the color contrasts in other slots show the same trend of change (FIGS. 2C-2E). The heat capacity of the material can be derived from the color contrast. After complete melting, the temperatures of samples reach the same level (FIG. 2F).

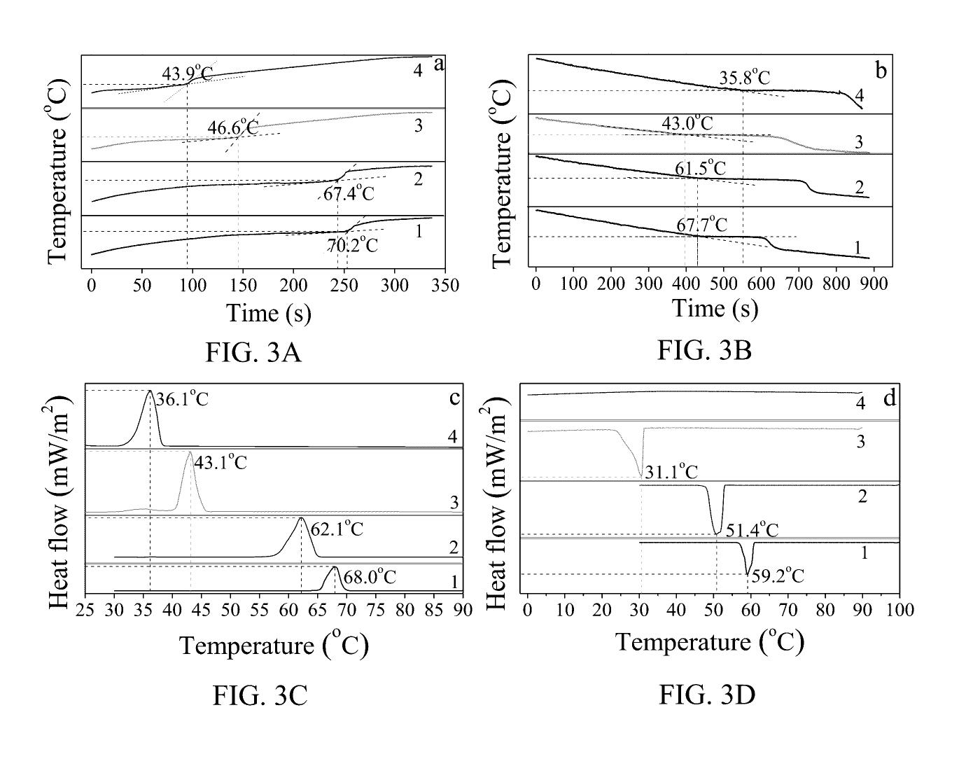

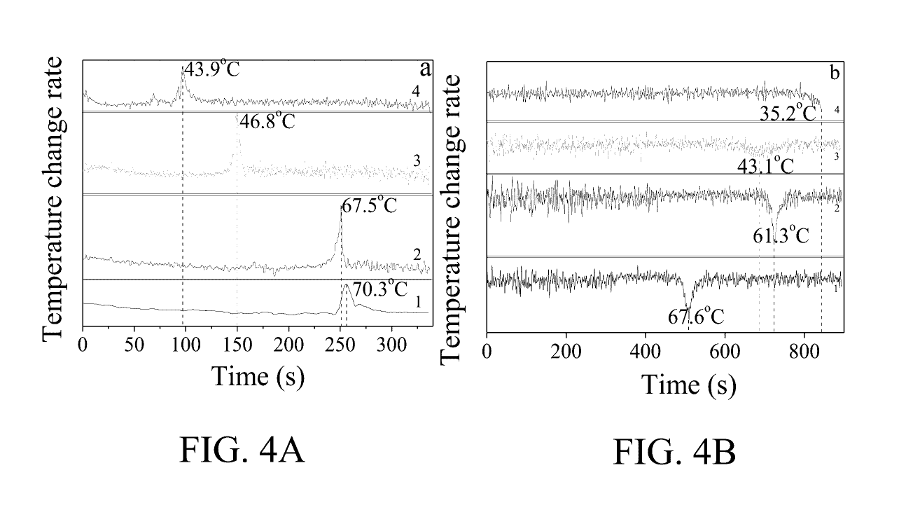

The emissivity of sample and the reflection temperature were calibrated with data extracted from recorded videos. FIG. 3A shows the temperature increase curves of the samples. An abrupt change in the slope can be found in each curve, which indicates the endpoint of the melting process. Two tangent lines were placed around each transition point to locate the melting point as shown in the picture. The melting temperatures of stearic acid, palmitic acid, lauric acid and icosane were determined to be 70.2, 67.4, 46.6 and 43.9° C., respectively. In order to determine the accuracy of the infrared imaging method, the four samples were sealed in enclosed aluminum pans and checked with DSC to determine their melting temperatures. As shown in their melting curves (FIG. 3C), the melting temperatures were 68.0, 62.1, 43.1 and 36.1° C. for stearic acid, palmitic acid, lauric acid and icosane, respectively, which are close to the reported values. The difference between the measured melting points and the DSC melting points is likely caused by impurity in the sample and non-homogenous heating effect associated with the slot. FIG. 3B shows the temperature profiles of the sample during the cooling process.

### Example 2

### Characterization of Nanoparticles Using Their Solidifying Temperature

A similar strategy was used to identify the freezing point of each sample from Example 1. These were determined to be 67.7, 61.5, 43.0 and 35.8° C. for stearic acid, palmitic acid, lauric acid and icosane, respectively. The measured freezing points are in the same range of the reported melting points, which indicated no supercooling occurs throughout thermal imaging. The lack of supercooling is likely due to edge effect of slot, which facilitates the heterogeneous nucleation. In comparison, the freezing points of the four materials (FIG. 3D) by DSC were several to tens of degrees lower than the ones measured through infrared camera. The difference is probably caused by supercooling, which is due to lack of nucleation site in smooth aluminum pans. The decreases in freezing points were 8.5, 10.1 and 11.9° C. for stearic acid, palmitic acid and lauric acid, respectively. No freezing peak was observed in the case of icosane whose low melting temperature (36.1° C.) can cause supercooling at temperature as low as 20° C. The driving force for heat transfer with low temperature difference is small, which produces heat flux below detection limit of DSC.

### Example 3

### Manufacturing and Use of Covert Taggant

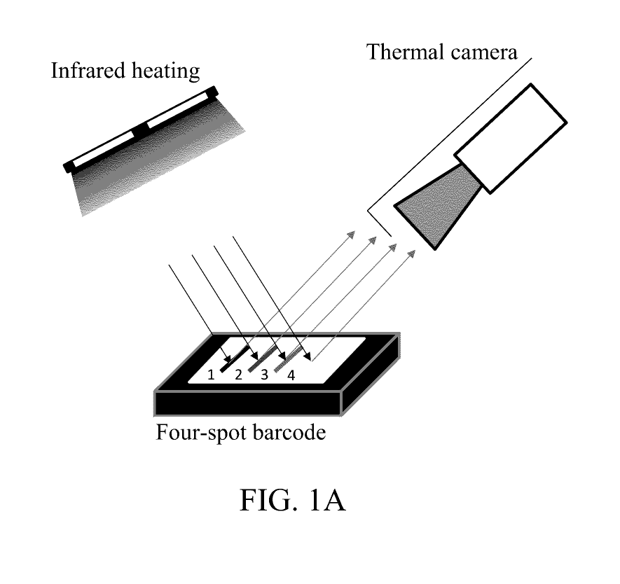

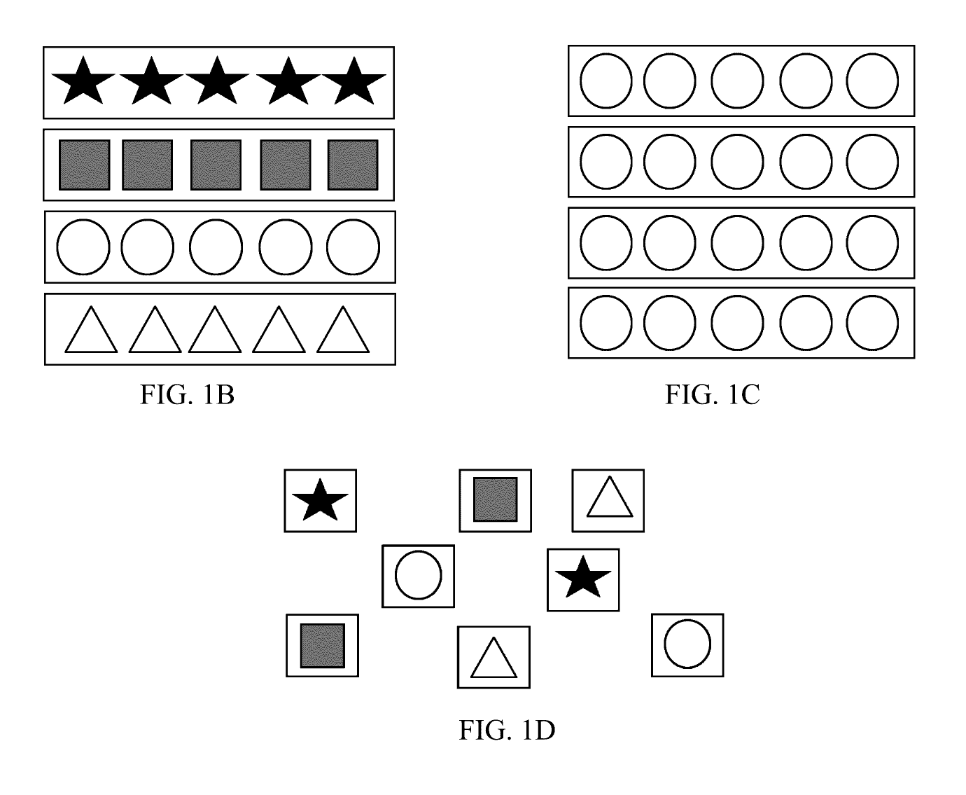

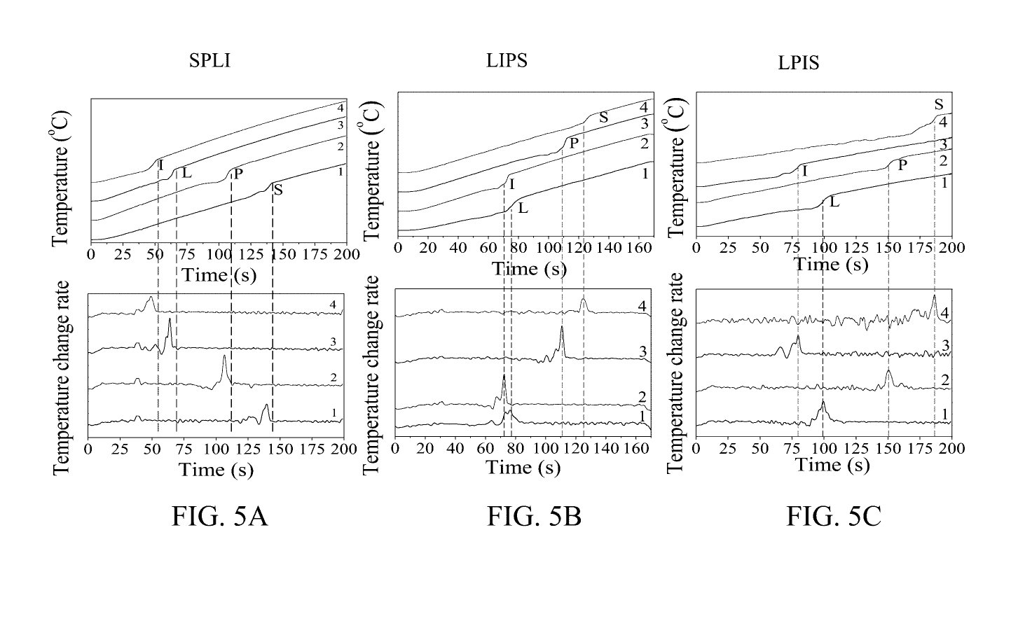

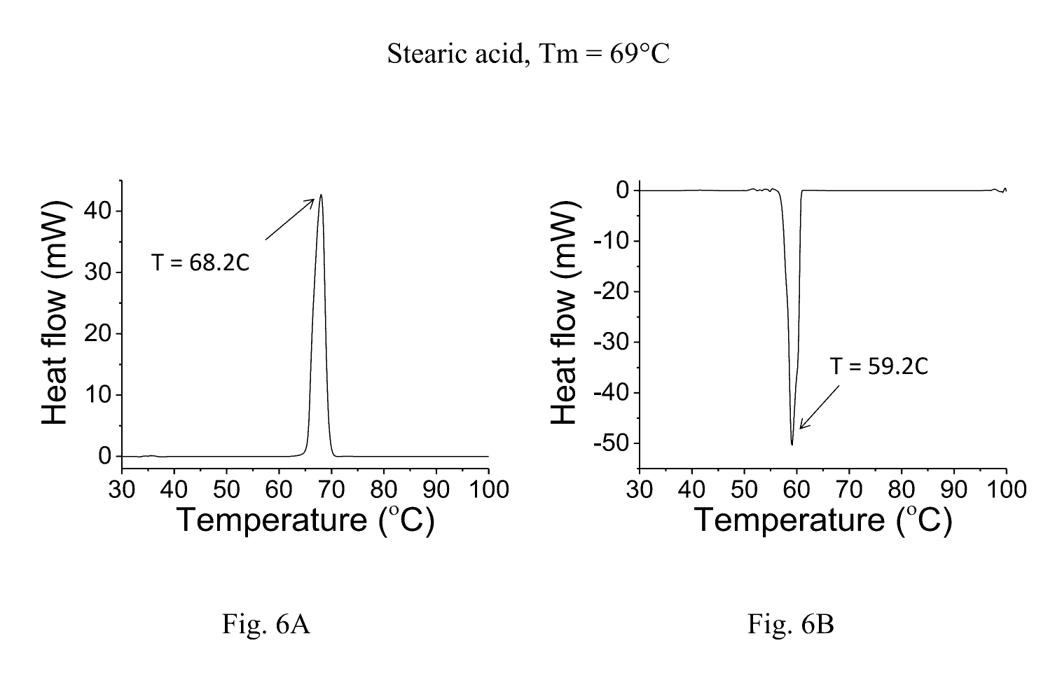

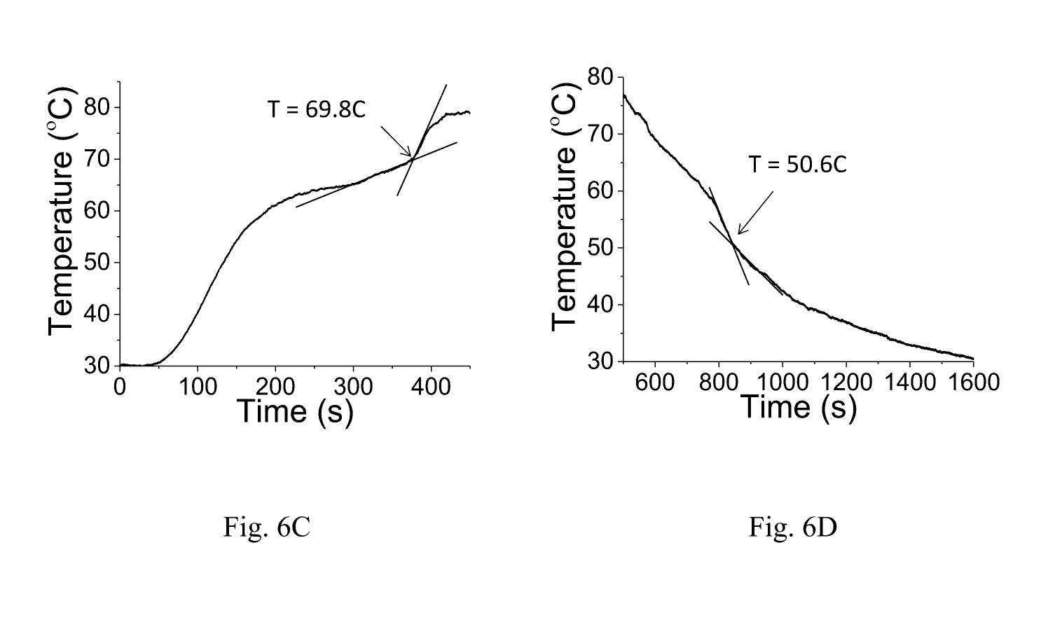

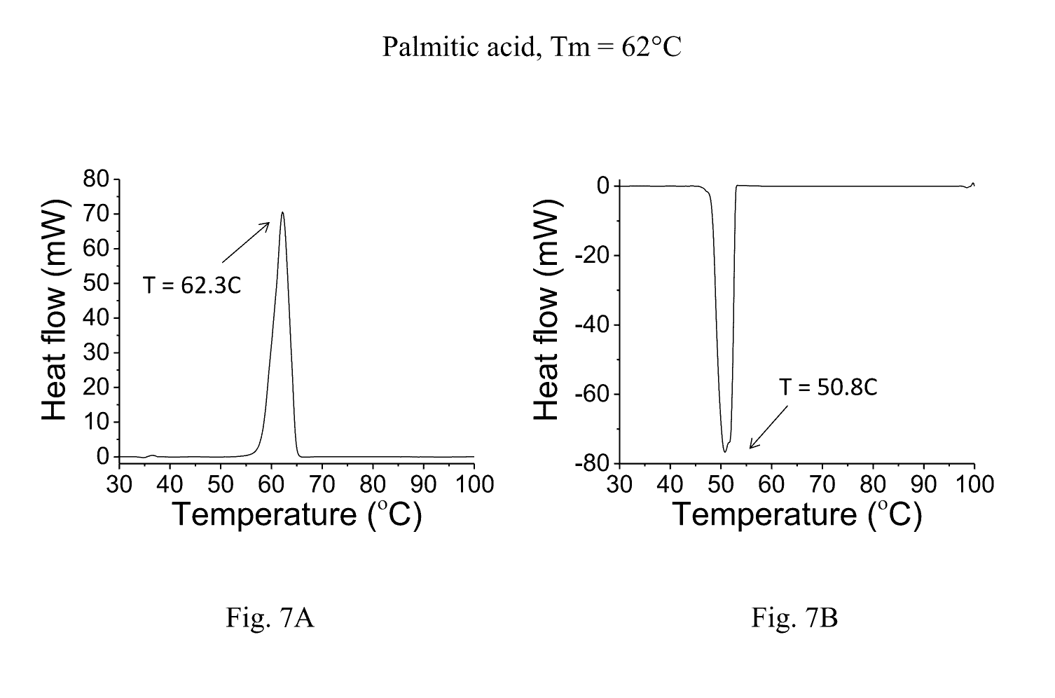

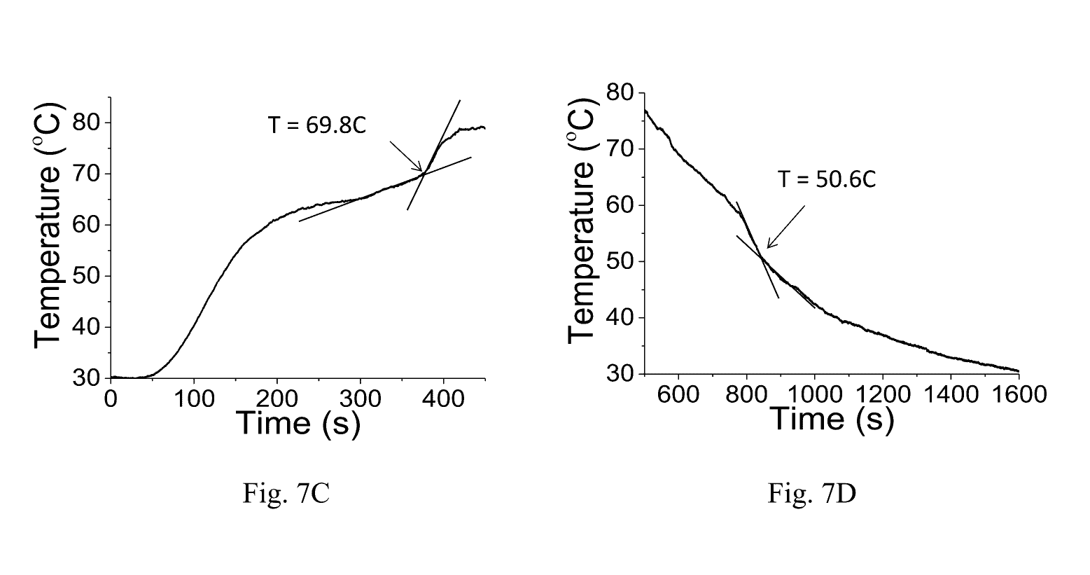

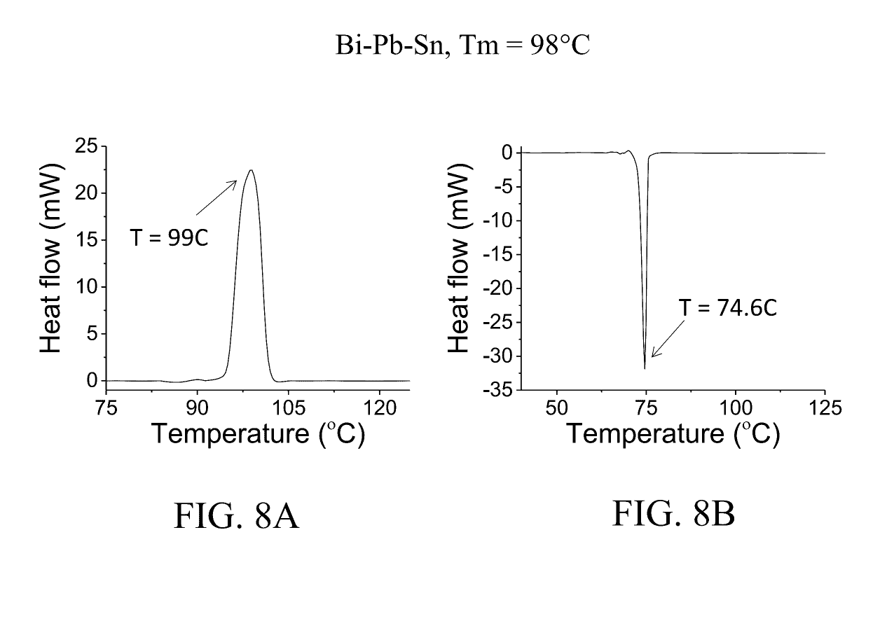

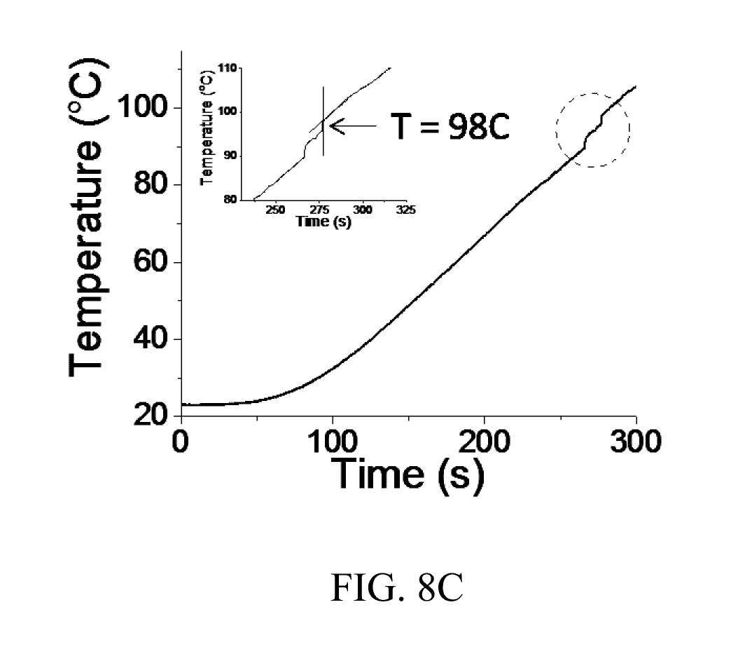

Selected PCMs (3-5 mg) were placed on a piece of printing paper in four locations. Each location contained one of the four PCMs (FIG. 1A). The total number of possible arrangements was 4⁴=256 based on the different combinations of printing locations and PCMs. Each barcode consisted of four sequential letters, where S stands for stearic acid, P stands for palmitic acid, L stands for lauric acid, and I stands for icosane. The paper was heated with an infrared source and recorded by the infrared camera. Data extracted with FLIR tools+ is shown in the upper three pictures in Figure FIGS. 5A-5C. Lines 1 to 4 stand for the temperature increasing curves of the PCMs at location 1 to 4. The rates of temperature change curves are shown in the lower three graphs. In the first barcode, the sequence of the four PCMs is stearic acid, palmitic acid, lauric acid and then icosane, forming the barcode SPLI. Similarly, the second and third barcodes are LIPS and LPIS.

### REFERENCE

1. Yoon, B. et al. Recent functional material based approaches to prevent and detect counterfeiting. J. Mater. Chem. C 1, 2388-2403 (2013).
2. Fayazpour, F. et al. Digitally encoded drug tablets to combat counterfeiting. Adv. Mater. 19, 3854-3858 (2007).
3. Botti, S. et al. Trace level detection and identification of nitro-based explosives by surface-enhanced Raman spectroscopy. J. Raman Spectrosc. 44, 463-468 (2013).
4. Kolla, P. The application of analytical methods to the detection of hidden explosives and explosive devices (vol 36, pg 800, 1997). Angew. Chem. Int. Ed. 36, 1371-1371 (1997).
5. Germain, M. E. & Knapp, M. J. Optical explosives detection: from color changes to fluorescence turn-on. Chem. Soc. Rev. 38, 2543-2555 (2009).
6. MacCrehan, W. A. A NIST Standard Reference Material (SRM) to Support the Detection of Trace Explosives. Anal. Chem. 81, 7189-7196 (2009).
7. Huang, C. B. et al. Unbreakable Codes in Electrospun Fibers: Digitally Encoded Polymers to Stop Medicine Counterfeiting. Adv. Mater. 22, 2657-2662 (2010).
8. Braeckmans, K. et al. Encoding microcarriers by spatial selective photobleaching. Nat. Mater. 2, 169-173 (2003).
9. Han, S. et al. Lithographically Encoded Polymer Microtaggant Using HighCapacity and Error-Correctable QR Code for Anti-Counterfeiting of Drugs. Adv. Mater. 24, 5924-5929 (2012).
10. Clelland, C. T., Risca, V. & Bancroft, C. Hiding messages in DNA microdots. Nature 399, 533-534 (1999).
11. Bera, D., Qian, L., Tseng, T. K. & Holloway, P. H. Quantum Dots and Their Multimodal Applications: A Review. Mater. 3, 2260-2345 (2010).
12. Cao, Y. W. C., Jin, R. C. & Mirkin, C. A. Nanoparticles with Raman spectroscopic fingerprints for DNA and RNA detection. Science 297, 1536-1540 (2002).
13. Nicewarner-Pena, S. R. et al. Submicrometer metallic barcodes. Science 294, 137-141 (2001)
14. Duong, B., et al., Covert thermal barcodes based on phase change nanoparticles. Scientific reports, 2014. 4.
15. Kawakami, K., Parallel thermal analysis technology using an infrared camera for high-throughput evaluation of active pharmaceutical ingredients: A case study of melting point determination. AAPS PharmSciTech, 2010. 11(3): p. 1202-1205.
16. Bera, D., et al., Quantum dots and their multimodal applications: a review. Materials, 2010. 3(4): p. 2260-2345.
17. Sakamoto, T., et al., Thermally sensitive recording type adhesive level. 2003, Google Patents.
18. Ma, Z., et al., Encoding and decoding nanoscale thermal barcodes for ultrahigh capacity identification systems. Applied Physics Letters, 2009. 95(23): p. 233101.
19. Ma, L., et al., Multiplexed highly sensitive detections of cancer biomarkers in thermal space using encapsulated phase change nanoparticles. Applied Physics Letters, 2009. 95(4): p. 043701.
20. Goda, K., K. K. Tsia, and B. Jalali, Amplified dispersive Fourier-transform imaging for ultrafast displacement sensing and barcode reading. Applied Physics Letters, 2008. 93(13): p. 131109.

What is claimed is:

1. A taggant comprising a plurality of phase change nanoparticles disposed in a two-dimensional array; wherein said plurality of phase change nanoparticles comprises one or more types of phase change nanoparticles, each type having a uniquely identifiable phase change temperature.

2. The taggant of claim 1, wherein the phase change nanoparticles comprise one or more materials selected from the group consisting of metals, organic materials, and combinations thereof.

3. The taggant of claim 1, wherein the phase change nanoparticles comprise one or more metals selected from the group consisting of aluminum, bismuth, cadmium, copper, gadolinium, indium, lead, magnesium, palladium, silver, tin, zinc, gold, nickel, antimony, and combinations thereof.

4. The taggant of claim 1, wherein the phase change nanoparticles comprise a eutectic alloy.

5. The taggant of claim 1, wherein the phase change nanoparticles comprise one or more paraffin waxes.

6. The taggant of claim 1, wherein the phase change nanoparticles comprise one or more materials selected from the group consisting of liquid crystals, proteins, organic acids, DNAs, and combinations thereof.

7. The taggant of claim 1 which is invisible to the unaided human eye.

8. The taggant of claim 1, wherein the phase change nanoparticles have a diameter larger than a thermodynamically critical diameter.

9. The taggant of claim 8, wherein the thermodynamically critical diameter is about 20 nm.

10. The taggant of claim 1, wherein the plurality of phase change nanoparticles can be optically heated and scanned or imaged in order to reveal their phase change temperature and position within the array, without the need for taggant sampling or destruction.

11. The taggant of claim 1, wherein melting peaks of the two or more types of phase change nanoparticles have a width at half-height from approximately 0.5° C. to 5.0° C.

12. The taggant of claim 1, wherein the phase change nanoparticles have a phase change melting time of 10 minutes or less.

13. The taggant of claim 1, wherein the phase change temperatures of the phase change nanoparticles are from about 30° C. to about 100° C.

14. The taggant of claim 1 comprising two or more types of said phase change nanoparticles, wherein the phase change temperatures of the two or more types are characterized by melting peaks that differ by at least 0.01° C.

15. The taggant of claim 1, comprising 3 or more types of phase change nanoparticles.

16. The taggant of claim 15, comprising 5 or more types of phase change nanoparticles.

17. The taggant of claim 1, wherein the phase change nanoparticles are encapsulated in microspheres.

18. The taggant of claim 1, wherein the taggant further comprises nanoparticles selected from the group consisting of magnetic nanoparticles, fluorescent nanoparticles, semiconductive nanoparticles, and combinations thereof.

19. The taggant of claim 1, wherein the two-dimensional array represents a serial number.

20. A tagged object comprising the taggant of claim 1.

21. A method for identifying an object using a taggant, the method comprising the steps of:
(a) providing an object tagged with the taggant of claim 1;
(b) irradiating the taggant with infrared radiation, whereby a temperature of the taggant increases over time;
(c) scanning or acquiring an image of the taggant with an infrared imaging device over a period of time;
(d) determining a phase change temperature and a position of the phase change nanoparticles; and
(e) identifying the object by matching the phase change temperature and position of said phase change nanoparticles with predetermined values for said phase change temperature and position in a library.

22. The method of claim 21, wherein the phase change temperature is determined by detecting one or more melting peaks indicative of the phase change temperatures of the nanoparticles.

23. The method of claim 21, wherein the phase change nanoparticles undergo a solid-to-liquid phase transition.

24. The method of claim 21, wherein the phase change nanoparticles undergo a liquid-to-solid phase transition.

25. The method of claim 21, wherein the taggant is continuously scanned or imaged in step (c).

26. A taggant reading system comprising:
an infrared illumination source;
an infrared imaging device; and
a processor; wherein the processor is programmed to direct the illumination source and imaging device to carry out the method of claim 21.

27. The system of claim 26, wherein the imaging device is a thermography camera.

28. The system of claim 26, wherein the processor is programmed to detect a code corresponding to a particular taggant and to transmit and/or display the code when detected.

29. The system of claim 28, wherein the processor is programmed to compare the code to a predetermined set of codes indicative of no identification or positive identification, and to transmit or display an identification or non-identification result.

30. A method for making a taggant, the method comprising depositing a plurality of phase change nanoparticles in a two dimensional array, wherein the plurality of phase change nanoparticles comprises one or more types of phase change nanoparticles, each type having a uniquely identifiable phase change temperature within the plurality of phase change nanoparticles.

31. A method for tagging an object, the method comprising associating the taggant of claim 1 with an object.
